(19) United States
(12) Patent Application Publication
(10) Pub. No.: US 2014/0023928 A1
(43) Pub. Date: Jan. 23, 2014

(54) ANODE ACTIVE MATERIAL FOR SECONDARY BATTERY AND SECONDARY BATTERY INCLUDING THE SAME

(71) Applicant: MK ELECTRON CO., LTD., Yongin-si (KR)

(72) Inventors: Sung Min JEON, Gwangju-si (KR); Jong Soo CHO, Seoul (KR); Jeong Tak MOON, Suwon-si (KR)

(73) Assignee: MK ELECTRON CO., LTD., Yongin-si (KR)

(21) Appl. No.: 13/665,485

(22) Filed: Oct. 31, 2012

(30) Foreign Application Priority Data
Jul. 19, 2012 (KR) 10-2012-0078964

(51) Int. Cl. H01M 4/134; H01M 4/46; H01M 4/38; H01M 4/42; B02C 23/00; B02C 19/06

(52) U.S. Cl. 429/220; 429/221; 429/223; 429/224; 429/229; 429/231.5; 429/218.1; 241/23; 241/5; 252/182.1

(57) ABSTRACT

An anode active material for a lithium secondary battery having a high capacity and a high efficiency of charge discharge characteristics. The anode active material includes a silicon mono-phase and an alloy phase formed of silicon with a metal element at least one selected from the group consisting of Ti, Ni, Cu, Fe, Mn, Al, Cr, Co, and Zn. The anode active material is a powder in which the silicon mono-phase is uniformly distributed in a matrix of the alloy phase, has particle size distribution defined as D0.1 and D0.9, and the value of D0.1-D0.9 is in a range from about 3 μm to about 15 μm.

### CROSS-REFERENCE TO RELATED PATENT APPLICATION

This application claims priority under 35 U.S.C. §119 from Korean Patent Application No. 10-2012-078964, filed on Jul. 19, 2012, in the Korean Intellectual Property Office, the disclosure of which is incorporated herein in its entirety by reference.

### BACKGROUND OF THE INVENTION

1. Field of the Invention

The present invention relates to a secondary battery, and more particularly, to an anode active material for a secondary battery that can provide a high capacity and a high efficiency of charge and discharge characteristics and a secondary battery including the same.

2. Description of the Related Art

Recently, lithium secondary batteries are used as a power source for portable electronic products such as mobile phones, notebook computers, etc. and application fields of the lithium secondary batteries has rapidly increased to large and medium-sized power sources for hybrid electric vehicles (HEV) and plug-in HEV. According to the increased application fields and increased demand, external shapes and sizes of the lithium secondary batteries have been changed in various ways, and also, a further higher capacity, better cycle performances, and safety are required than those required by the conventional small lithium secondary batteries.

Generally, a lithium secondary battery is manufactured using a material allowing intercalation and deintercalation of lithium ions as an anode and cathode. After disposing a porous separation film between the anode and cathode, an electrolyte is injected therebetween. Electricity is generated as a result of an oxidation-reduction reaction by the intercalation and deintercalation of lithium ions at the anode and cathode.

Graphite, which is widely used as an anode active material in conventional lithium secondary batteries, has a layered structure, and thus, has a very useful characteristic at intercalation and deintercalation of lithium ions. Theoretically, graphite has a capacity of 372 mAh/g. However, recently, due to increased demands for a high capacity lithium secondary battery, it is required to develop a new electrode that can replace graphite. Therefore, studies have been actively conducted to commercialize electrode materials such as Si, Sn, Sb, and Al as a high capacity anode active material that forms an electrochemical alloy with lithium ions. However, Si, Sn, Sb, or Al shows volume changes (i.e., volume increases or decreases) when the electrochemical alloy formed with lithium ions is charged or discharged. The volume change according to the charge/discharge degrades cycle performances of an electrode to which an active material such as Si, Sn, Sb, or Al is used. Also, the change of volume causes cracks in a surface of the electrode active material, and the formation of continuous cracks leads to minute separation of the active material at the surface of the electrode, which acts as another reason for the degradation of cycle performances.

### REFERENCE PATENTS

1. Korean Patent No. 2009-0099922 (Published on Sep. 23, 2009)
2. Korean Patent No. 2010-0060613 (Published on Jun. 7, 2010)
3. Korean Patent No. 2010-0127990 (Published on Dec. 7, 2010)

### SUMMARY OF THE INVENTION

The present invention provides an anode active material for a lithium secondary battery having a high capacity and a high efficiency of charge discharge characteristics.

The present invention also provides a lithium secondary battery that includes the anode active material.

According to an aspect of the present invention, there is provided an anode active material for a lithium secondary battery, the anode active material including: a silicon mono-phase; and an alloy phase formed of silicon with at least one metal selected from the group consisting of Ti, Ni, Cu, Fe, Mn, Al, Cr, Co, and Zn, wherein the anode active material is a powder in which the silicon mono-phase is uniformly distributed in a matrix of the alloy phase, the powder has a particle size distribution defined as D0.1 and D0.9, and a D0.9-D0.1 value of the powder is in a range from about 3 μm to about 15 μm.

The value of D0.1 of the powder may be greater than 1 μm.

The value of D0.9 of the powder may be smaller than 16 μm.

The value of D0.1 of the powder may be greater than 1 μm and the value of D0.9 of the powder may be smaller than 10 μm.

The value of D0.9-D0.1 may be in a range from about 3 μm to about 10 μm.

According to an aspect of the present invention, there is provided an anode active material for a lithium secondary battery, the anode active material including: a silicon mono-phase; and an alloy phase formed of silicon and a metal, wherein the anode active material powder has a projected area A of a plane-projected powder particle and an outline length P of the plane-projected powder particle, and a roundness R1 of the particle is defined as

$$R 1 = \frac{2 \sqrt{π A}}{P} ,$$

wherein the anode active material powder has a roundness in a range from about 0.3 to about 1.0.

The plane-projected powder particle has a rounded outline D and a rounded outline length PE of the rounded outline D, and a roughness R2 is defined as R2=P/PE, and the anode active material powder may have a roughness in a range from about 0.8 to about 1.0.

The anode active material has a long particle diameter L and a short particle diameter S of the plane-projected powder particle, and an anisotropy ratio R3 is defined as R3=L/S, and the anode active material has an anisotropy ratio in a range from about 1 to about 3.5.

According to another aspect of the present invention, there is provided a method of manufacturing an anode active material for a lithium secondary battery, the method including: mixing silicon with a metal element at least one selected from the group consisting of Ti, Ni, Cu, Fe, Mn, Al, Cr, Co, and Zn; cooling the mixture by using a melt spinner method; and forming a powder by grinding the cooled mixture, wherein D0.9-D0.1 of the manufactured powder has a value in a range from about 3 μm to about 15 μm.

The forming of the powder may include grinding the cooled mixture by using an air jet milling method.

The forming of the powder may include grinding the cooled mixture by using an attrition milling method.

The powder may have a particle diameter in a range from about 1 μm to about 10 μm.

According to another aspect of the present invention, there is provided a lithium secondary battery including an anode active material, the lithium secondary battery including: a silicon mono-phase; and an alloy phase formed of silicon and a metal, wherein the anode active material powder has a projected area A of a plane-projected powder particle and an outline length P of the plane-projected powder particle, and a roundness R1 of the particle is defined as

$$R 1 = \frac{2 \sqrt{π A}}{P} ,$$

wherein the anode active material powder has a roundness R1 in a range from about 0.3 to about 1.0.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic drawing showing various dimensions of powder which is obtained from a plane projected image of a powder particle;

FIG. 2 is a table summarizing grinding conditions and particle size distribution of an anode active material for a secondary battery according to an embodiment of the present invention;

FIG. 3 is a table summarizing electrochemical characteristics of anode active materials according to embodiments of the present invention and comparative examples;

FIG. 4 is a graph showing lifetime characteristics (cycle characteristics) of an anode active material for a lithium secondary battery according to an embodiment of the present invention;

FIGS. 5A through 5C are scanning electron microscope (SEM) images of anode active material powders ground by using a ball milling method, an attrition milling method, and an air jet milling method;

FIGS. 6A through 6C are graphs showing particle size distribution of anode active material powders ground by using a ball milling method, an attrition milling method, and an air jet milling method; and

FIGS. 7A through 7C are graphs showing roundness, roughness, and aspect ratio of powders according to embodiments of the present invention.

### DETAILED DESCRIPTION OF THE INVENTION

Hereafter, the present invention will be described more fully with reference to the accompanying drawings, in which exemplary embodiments of the present invention are shown. This invention may, however, be embodied in many different forms and should not construed as limited to the exemplary embodiments set forth herein. Rather, these embodiments are provided so that this disclosure will be thorough and complete, and will fully convey the scope of the invention to those of ordinary skill in the art. In the drawings, lengths and sizes of layers and regions may be exaggerated for clarity. As used herein, the term “and/or” includes any and all combinations of one or more of the associated listed items. Like numbers refer to like elements throughout. Furthermore, various elements and regions in the drawings are schematically drawn. Accordingly, the technical spirit of the present invention is not limited to the relative sizes and gaps shown in the accompanying drawings. In the embodiments of the present invention, at % (atom %) indicates a percentage of the number of atoms occupied by a corresponding component in the total atom numbers of an alloy.

An anode active material for a secondary battery according to the present invention is an anode active material that includes a silicon mono-phase and a silicon alloy phase in which silicon forms an alloy with at least a metal selected from the group consisting of Ti, Ni, Cu, Fe, Mn, Al, Cr, Co, and Zn. The anode active material is a powder in which the silicon mono-phase is uniformly distributed in a matrix of the alloy phase. The powder has a particle size distribution defined as D0.1 and D0.9, and the value of D0.1 to D0.9 of the powder may be in a range from about 3 μm to about 15 μm. Also, a value of D0.1 of the powder may be greater than 1 μm, and a value of D0.9 may be smaller than 16 μm.

In the current invention, D0.1 denotes a particle size at which an accumulated volume of the powder is 10%, D0.5 denotes a particle size at which an accumulated volume of the powder is 50%, and D0.9 denotes a particle size at which an accumulated volume of the powder is 90% from a cumulative size distribution curve. D1.0 denotes a particle size at which an accumulated volume of the powder is 100%. In other words, it denotes a size of the coarsest particle included in the powder.

In general, when the particle size of the powder of an anode active material is very small, a lithium diffusion path from a surface of a particle to a silicon mono-phase is reduced. Accordingly, the rate characteristic of the anode active material may be improved. For example, a high capacity may be realized at high charge and discharge rates (i.e., high current rates during charges and discharges). However, when the anode active material has a diameter of less than 1 μm, an initial irreversible capacity is increased due to the increase in the specific surface area of the anode active material particle. Also, an amount of a binder for binding the anode active material particles to a current collector is increased, and thus, the current density per unit volume of an electrode may be reduced. Also, when the anode active material has a diameter that is greater than 16 μm, air gaps between the electrode particles may be larger. Accordingly, the current density per unit volume of the electrode may be reduced. Also, the diffusion path of lithium ions is increased due to the large particle sizes, and thus, an output characteristic may be reduced. In the anode active material according to the present invention, D0.1 is greater than 1 μm and D0.9 is less than 16 μm. Therefore, the anode active material may have good electrochemical characteristics.

In the embodiments according to the present invention, D0.1 is greater than 1 μm, that is, a ratio of powder having a particle size that is less than 1 μm is small in the entire powder. When a large amount of fine powder is included in an initial powder, the generation of solid electrolyte interface (SEI) is increased in a charge and discharge process, which increases the consumption of an electrolyte. Also, a capacity decrease due to depletion of the electrolyte may occur after performing a plurality of charges and discharges, which may lead to deterioration of cycle-life characteristics of the secondary battery. In the embodiments of the present invention, the anode active material includes a small ratio of fine powder, and accordingly, cycle-life characteristics of the secondary battery may be improved.

In the embodiments of the present invention, the powder may have roundness R1 in a range from about 0.3 to about 1. The roundness R1 may be defined as

$$R = \frac{2 \sqrt{π A}}{P}$$

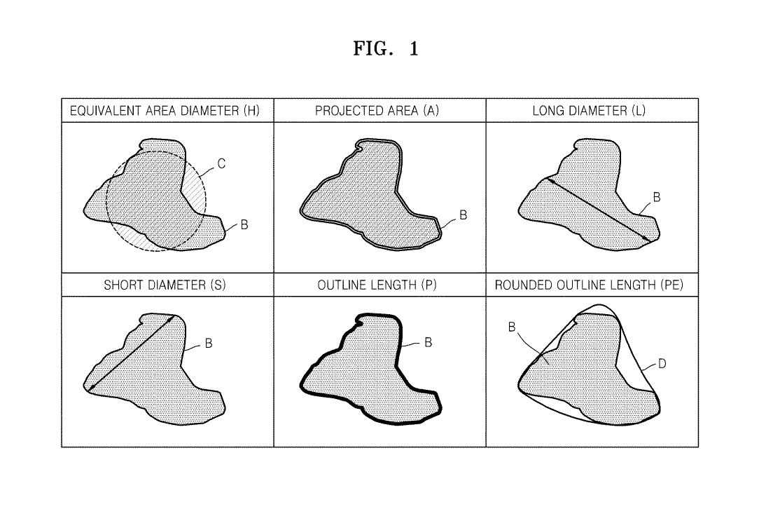

by dimensions obtained from a plane-projected image of a powder particle. FIG. 1 shows powder dimensions that may be obtained from a plane-projected image of a powder particle. A plane-projected particle B of a powder particle is obtained by projecting a three-dimensional shape to a two-dimensional plane, and an equivalent area diameter H is obtained from an equivalent area circle C having an area the same as that of the plane-projected particle B. A diameter of the equivalent area circle C may be defined as the equivalent area diameter H. A projected area A indicates an area of the plane-projected particle B. A long diameter L indicates the longest diameter of the plane-projected particle B, and a short diameter S indicates the second longest diameter of the plane-projected particle B. An outline length P indicates a length of the circumference of the plane-projected particle B. Also, when a rounded outline D that surrounds the plane-projected particle B is defined by connecting an edge in a direction of the long diameter L and an edge in a direction of the short diameter S of the projected particle B, a rounded outline length PE indicates a length of circumference of the rounded outline D.

When a roundness R1 (in other words, sphericity) of a powder particle approaches 1, the shape of the powder particle is close to a circle. For example, it is assumed that when a powder has a circular shape having a radius r, the projected area A is πr2 and an outline length of the powder particle is 2πr. Therefore, the roundness R1 has a value of 1. If a powder has an oval shape or a rough shape while having the same projected area, the outline length P of the powder particle is increased, and thus, the roundness R1 has a value of R1<1.

When a powder of an anode active material has an irregular or sharp particle shape, punch holes like pinholes occur in a separation film in a process of forming an electrode by agglomerating the powder, thereby causing a safety problem of the secondary battery. Also, when a powder of an anode active material has an irregular or sharp particle shape, powder may not be uniformly coated on a foil on which an electrode is applied, and thus, electrochemical characteristics, such as capacity and cycle-life of the secondary battery, may be reduced. The anode active material according to the present invention has a roundness R1 in a range from about 0.3 to about 1.0, and more specifically, in a range from about 0.6 to about 1.0. The anode active material according to the present invention has a large roundness R1, and thus, the reduction of the electrochemical performance due to the occurrence of punch holes or irregular distribution of particles may be prevented.

The anode active material according to the present invention may have a roughness R2 (in other words, ratio of perimeter lengths) in a range from about 0.8 to about 1.0. The roughness R2 is defined as R2=P/PE, where P is an outline length of a powder particle and PE is a rounded outline length of the powder particle. That is, roughness=(outline length of powder particle)/(rounded outline length of powder particle). Accordingly, if a particle surface is very rough, the roughness R2 is relatively small, and as the roughness R2 approaches 1.0, the particle surface has a smooth surface. The anode active material according to the present invention has a roughness R2 in a range from about 0.8 to about 1.0, and thus, as in the case of the roundness R1 described above, powder particles of an anode active material having a smooth surface may be uniformly distributed in an anode electrode, thereby improving the electrochemical performance of the secondary battery.

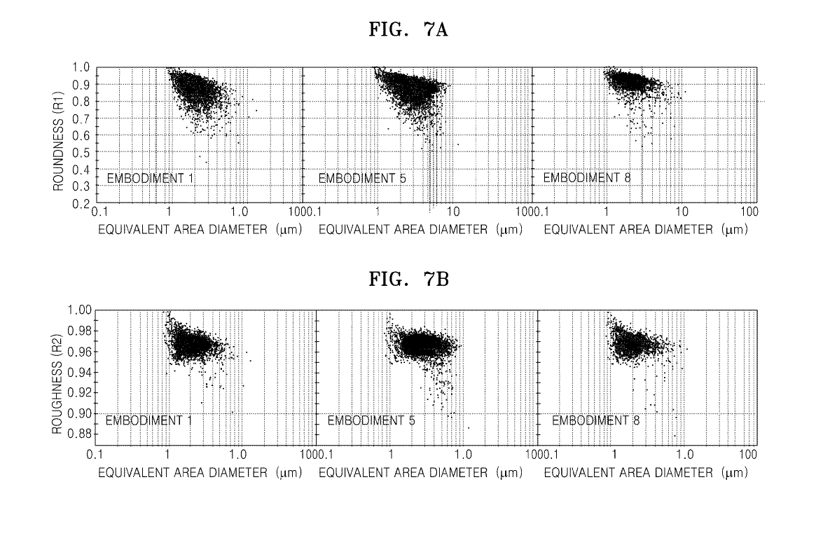

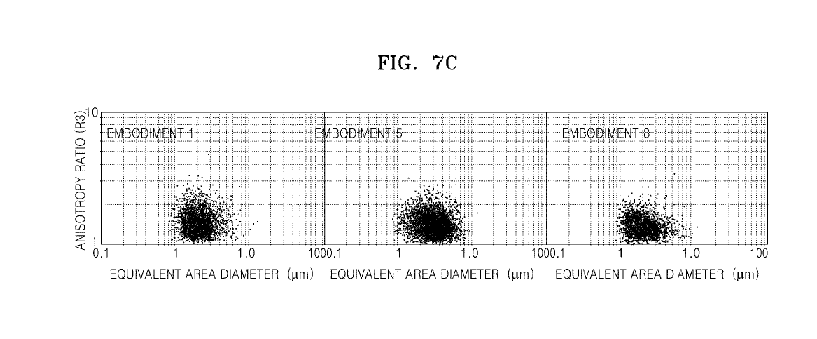

The anode active material according to the present invention may have an anisotropy ratio R3 (in other words, elongation ratio, aspect ratio) in a range from about 1 to about 3.5. The anisotropy ratio R3 is defined as R3=L/S, wherein L is a long particle diameter L of a powder particle and S is a short particle diameter S of the powder particle. That is, the anisotropy ratio R3 is defined by a ratio between the long particle diameter and the short particle diameter of a powder projection B. When the anisotropy ratio R3 is close to 1, a difference between the long particle diameter L and the short particle diameter S is small, and thus, the three-dimensional powder particle may have a shape close to that of a sphere (i.e., a projected particle B has a shape of a circle). The powder particle according to the present invention has an anisotropy ratio R3 in a range from about 1.0 to about 3.5. Therefore, the powder particle does not have a large difference between the long particle diameter L and the short particle diameter S, and may have a shape close to that of a sphere. Also, as in the case of the roundness R1 described above, the powder particles may be uniformly distributed in the anode electrode, thereby improving the electrochemical performance of the lithium secondary battery. The roundness R1, the roughness R2, and the anisotropy ratio R3 of a powder particle are described below in detail with reference to FIGS. 7A through 7C.

Hereinafter, experiment results of an anode active material for a lithium secondary battery according to an embodiment of the present invention will now be described.

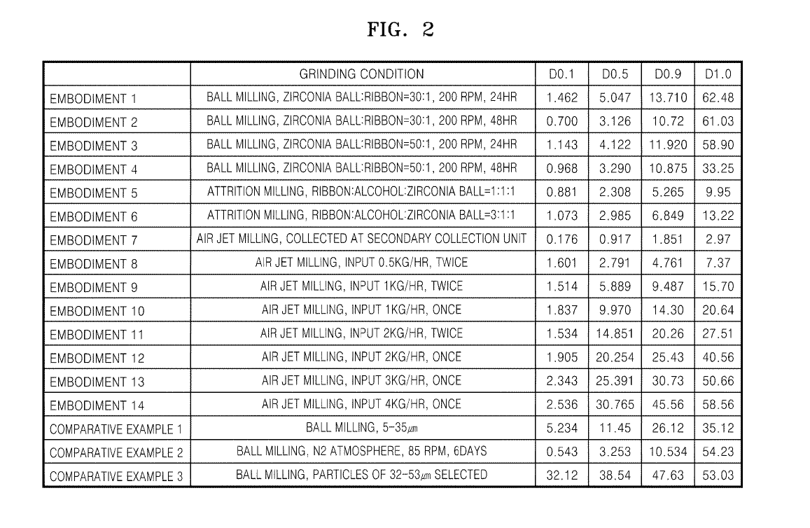

FIG. 2 is a Table summarizing grinding conditions and particle size distribution of an anode active material for a secondary battery according to an embodiment of the present invention.

Embodiments 1 through 14 correspond to powders ground an anode ribbon of an anode active material by varying grinding conditions. More specifically, Embodiments 1 through 4 show powders ground in a ball mill, Embodiments 5 and 6 show powders ground in an attrition mill, and Embodiments 7 through 14 show powders ground by an air jet mill.

The method of manufacturing the powder ground by a ball mill according to Embodiment 1 is as follows:

A melt was formed by melting a mixture having an atomic percentage (at %) of silicon:nickel:titanium=68:16:16 by using an arc melting process and a high frequency induction heating process. The melt was quenched (i.e., cooled rapidly) to form a quenched solid body. At this point, the quenching process may be performed by using a melt spinner, and the quenched solid body may be formed in a solid body having a long ribbon shape. Thus, the solid body may be referred to as an anode ribbon. The quenched solid body may include silicon mono-phase and silicon-nickel-titanium alloy phase. The quenched solid body has a structure in which silicon crystal particles having sizes of a few nanometers form an interface with the silicon-metal alloy phase by miniaturizing the particle size, and thus, are distributed in the silicon-metal alloy phase.

Afterwards, the quenched solid body was ground by using a ball mill to form an anode active material powder. At this point, a mixture of zirconia balls:ribbon=30:1 was placed in the ball mill having a diameter of 500 mm and the mixture was ground for 24 hours at 200 rpm. The produced powder was sieved with a 400-mesh sieve. Afterwards, the particle size distribution of the powder was obtained by using a particle size analyzer, Mastersize 2000 from Malvern.

As described above, D0.1 denotes a particle size at which an accumulated volume of the powder is 10%, D0.5 denotes a particle size at which an accumulated volume of the powder is 50%, and D0.9 denotes a particle size at which an accumulated volume of the powder is 90% from a cumulative size distribution curve. D1.0 denotes a particle size at which an accumulated volume of the powder is 100%; in other words, it denotes a size of the coarsest particle included in the powder.

The measurement result showed that the powder according to Embodiment 1 has a particle size distribution of D0.1˜D0.9 is in a range from about 1.462 μm to about 13.71 μm.

Anode active material powders according to Embodiments 2 through 14 were respectively formed by varying the ratio of zirconia ball and ribbon, rpm, and milling time. However, other conditions are the same as the method described in Embodiment 1.

The anode active material powders according to Embodiments 5 and 6 were formed by using an attrition mill. In the case of Embodiment 5, the same anode ribbon used in Embodiment 1 was used. The volume ratio of ribbon:anhydride alcohol:zirconia ball was controlled to 1:1:1 (which corresponds to 100 g of ribbon, 300 g of anhydride alcohol, and 1.5 kg of zirconia ball in a 1-liter container), and the mixture was ground in an attrition mill for 1.5 hours at 500 rpm. Afterwards, the powder was separated from anhydride alcohol by using a centrifugal separator. After drying the powder for 3 days in a drier, the particle size distribution of the powder was measured. In the case of Embodiment 6, a volume ratio of ribbon : anhydride alcohol:zirconia ball was controlled to 3:1:1 (which corresponds to 300 g of ribbon, 300 g of anhydride alcohol, and 1.5 kg of zirconia ball in a 1-liter container), and the mixture was ground by using an attrition mill.

The anode active material powders according to Embodiments 7 through 14 were formed by using an air jet mill. At this time, the anode ribbon was formed using the same method as in Embodiment 1, and a side pressure of 0.7 Mpa and an ejector pressure of 0.7 MPa were used. The operation of the air jet mill is described in detail below. In Embodiments 7 through 14, collecting position of powder, ribbon introducing speed, and the number of grindings were controlled to have particle size distributions different from each other. For example, in the case of Embodiment 7, the powder was collected in a secondary collection unit of the air jet mill, and in the case of Embodiment 8, the powder was obtained by performing the entire grinding process twice while adding (i.e., introducing) the anode ribbon at a rate of 0.5 kg per hour. In Embodiment 9, the powder was obtained by performing the entire grinding process twice while adding the anode ribbon at a rate of 1 kg per hour, and in Embodiment 10, the powder was obtained by performing the entire grinding process once while adding the anode ribbon at a rate of 1 kg per hour. In Embodiment 11, the powder was obtained by performing the entire grinding process twice while adding the anode ribbon at a rate of 2 kg per hour, and in Embodiments 12 through 14, the powders were obtained by performing the entire grinding process once while adding the anode ribbon at a rate of 2 kg, 3 kg, and 4 kg per hour, respectively.

D0.1, D0.5, D0.9, and D1.0, which denote the particle size distribution of the powders formed according to Embodiments 1 through 14 of the present invention, are shown in FIG. 2.

In Comparative Example 1, an anode active material having powder particles in a range from about 5 μm to about 35 μm was formed by using a ball milling process as disclosed in Korean Patent Publication No. 10-2000-7004942. In Comparative Example 2, an anode active material powder was formed by using a method disclosed in U.S. Patent Publication No. 2010/0288077, that is, a ball milling process was performed under a nitrogen atmosphere at 85 rpm for 6 days. In Comparative Example 3, an anode active material powder was obtained by using a method disclosed in the U.S. Pat. No. 7,498,199, that is, after forming an anode ribbon and milling the anode ribbon by using a ball mill, anode active material particles having sizes in a range from about 32 μm to about 53 μm were selected.

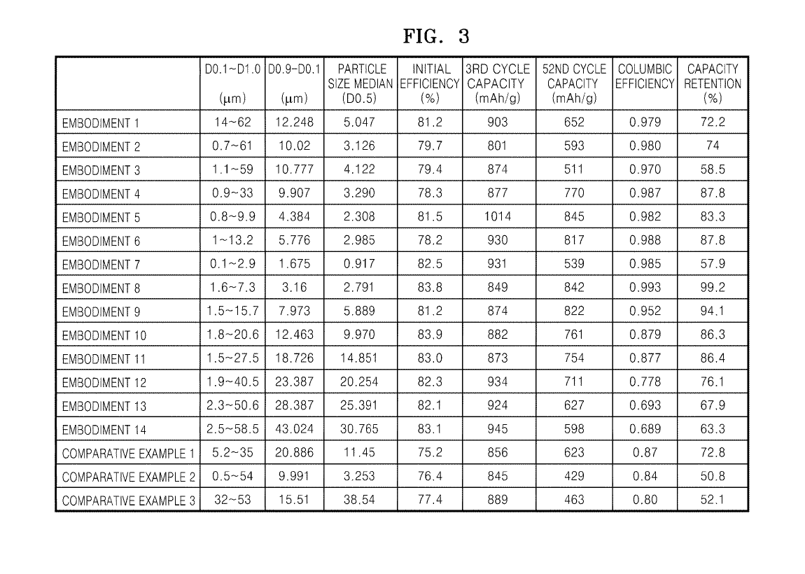

FIG. 3 is a Table summarizing electrochemical characteristics of anode active materials according to embodiments of the present invention and comparative examples.

Referring to FIG. 3, the particle size distribution of D0.1˜D1.0 and D0.9-D0.1, median particle size (D0.5), initial efficiency (ratio of a discharge capacity with respect to a charge capacity)(%), capacity at third cycle (mAh/g), capacity at 52nd cycle (mAh/g), coulombic efficiency at 52nd cycle (%), and capacity retention (i.e., cycle-life) at 52th cycle (%) of the powders according to Embodiments 1 through 14.

The evaluations of electrochemical characteristics are performed by the following methods:

After forming slurries by mixing the anode active material powders for lithium secondary batteries, according to Embodiments 1 through 14 described above, with an organic binder and a carbon group conductive material, the slurries were coated on an anode current collector such as a Cu foil, and afterwards, anode electrodes were manufactured by drying the resultant product. Afterwards, coin-type half cells were manufactured using the anode electrodes.

Of the powders having various particle size distributions, according to Embodiments 1 through 14, the anode active material powder according to Embodiment 8 shows the best electrochemical characteristics. The anode active material powder of Embodiment 8 shows an initial efficiency of 83.8% which is the second highest, capacity retention of 99.2% which is the highest, and a coulombic efficiency of 0.993 which is the highest.

The anode active material powders according to Embodiments 5 and 6 respectively have high capacities of 1014 mAh/g and 930 mAh/g. D0.1 to D1.0 of the anode active material powder according to Embodiment 5 is in a range from about 0.8 μm to about 9.9 μm and D0.1 to D1.0 of the anode active material powder according to Embodiment 6 is in a range from about 1 μm to about 13.2 μm, which are relatively small when compared to the particle sizes of anode active material powders according to Embodiments 1 through 4 and Comparative examples 1 through 3. If the average diameter of a powder is small, a surface area of the powder that may act as an active region of lithium ions for charge and discharge is increased at initial cycles, and thus, an initial capacity of a lithium secondary battery may be increased.

FIG. 4 is a graph showing lifetime characteristics (cycle characteristics) of an anode active material for a lithium secondary battery according to an embodiment of the present invention.

In the case of Embodiments 8 and 9, the anode active materials show high cycle-life characteristics. In particular, in the case of Embodiment 8, a cycle-life characteristic of 99.2% is shown at 52 cycles. Embodiments 7 through 14 show anode active material powders ground by an air jet mill that have different particle size distributions. In the case of Embodiment 8, D0.1 is 1.601 μm and D0.9 is 4.761 μm, and in the case of Embodiment 9, D0.1 is 1.514 μm and D0.9 is 9.487 μm. That is, the anode active material powders according to Embodiments 8 and 9 respectively have D0.9-D0.1 of 3.160 μm and 7.973 μm, that is, the powders show uniform particle size distributions. When the particle size distribution of a powder is uniform, a volume change of the anode active material during repeated charge and discharge operations may be effectively mitigated, and thus, the cycle-life characteristic of a lithium secondary battery may be improved. In Embodiment 7, the anode active material powder has D0.1 of 0.176 μm, D0.5 of 0.917 μm, and D0.9 of 1.851 μm, that is, in general, the powder shows a uniform particle size distribution, but includes a relatively large amount of fine particles having an average diameter of 1 μm or less. When an initial powder includes a large amount of fine particles, the occurrence of SEI increases in a process of performing charge and discharge operations, which may cause an electrolyte depletion problem, and accordingly, a capacity may be rapidly reduced beyond specific cycles, thereby deteriorating the cycle-life characteristic of the lithium secondary battery.

When the anode active material powder has a particle diameter that is less than 1 μm, the specific surface area of the anode active material powder is increased. The increase in the specific surface area of the anode active material powder increases the initial irreversible capacity of the lithium secondary battery, and also, increases the amount of binder to combine the anode active material to a current collector, and thus, the current density per unit volume of the lithium secondary battery may be reduced. When the anode active material powder has a particle diameter that is greater than 16 μm, the size of pores between the electrode particles may be increased, and accordingly, the current density per unit volume of the lithium secondary battery may be reduced. Also, due to the large particle sizes, the diffusion path of lithium ions may be increased, and as a result, an output characteristic of the lithium secondary battery is reduced.

Hereinafter, a method grinding the anode active material according to the present invention will now be described.

According to the present invention, when an attrition milling method is used, the anode active material may be ground finer than a ball milling method. For example, in the ball milling method, large particles are ground to small particles by using a vertically falling energy of balls. However, in an attrition milling method, the anode active material is ground by a kinetic energy of grinding rods. Therefore, the powder ground by an attrition mill may have a uniform particle size distribution.

In an air jet milling method, an anode active material ribbon is ground in a chamber by highly compressed air that is ejected from an air head through a grinding nozzle. More specifically, a jet air stream injected into the grinding chamber forms a high-speed circling current. At this point, the raw material to be ground is sucked into the grinding chamber by a jet nozzle. The raw material particles are continuously ground in the grinding chamber by a centrifugal force, and ground particles are discharged through a central discharge hole. The anode active material ribbon is ground by using high pressure and high speed air and ground particles are further ground by colliding with each other. Therefore, the wearing of mechanical parts or contamination due to foreign materials may be prevented. Also, particles that have sizes greater than a desired particle size, that is, unground particles, are discharged to the outside through a classifier for regrinding. Particles that have sizes smaller than a required particle size, that is, fine particles, are removed by blowing a counter air flow to convey the fine particles to a vacuum cleaner or be collected in a secondary collector. Accordingly, particles having a size that is smaller than a predetermined size may be filtered. For example, when the ball milling method or the attrition milling method is used, ground powders are sieved by using a specific mesh size. In this case, particles having sizes greater than a required size may be filtered. However, particles having sizes smaller than the required size may not be filtered. When an air jet milling method according to the current invention is used, particles having sizes smaller than a specific size may be effectively filtered.

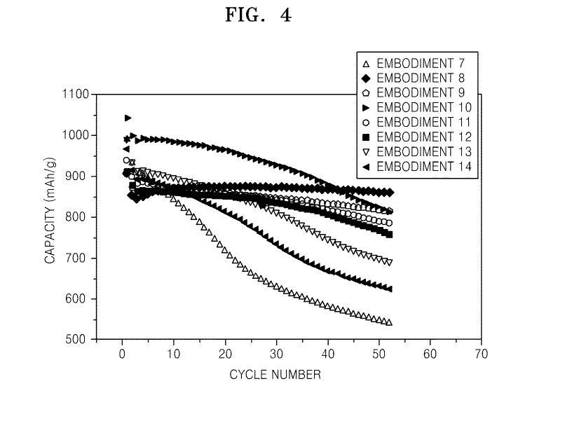

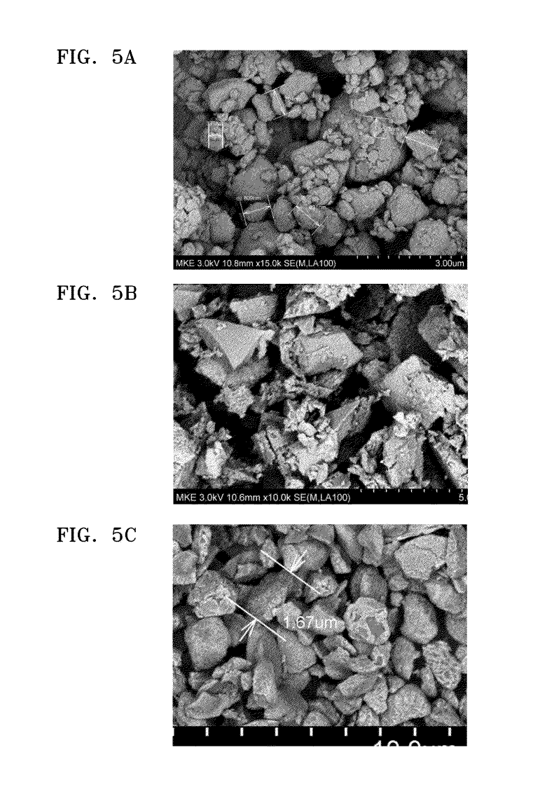

FIGS. 5A through 5C are scanning electron microscope (SEM) images of anode active material powders ground by using a ball milling method, an attrition milling method, and an air jet milling method, respectively.

Referring to FIG. 5A, particles have a rounded surface and show no severe roughness. However, also, it is observed that a large amount of fine particles having a size less than 1 μm (for example, 794 nm, 573 nm, and 397 nm, etc.) are agglomerated. Referring to FIG. 5B, it is observed that particles having large sizes and fine particles having a size less than 1 μm are mixed, and some of the particles have an unrounded sharp surface. Referring to FIG. 5C, particles have a rounded smooth surface. Also, particles having a size greater than 1 μm are mainly observed, and particles having a size less than 1 μm are hardly observed.

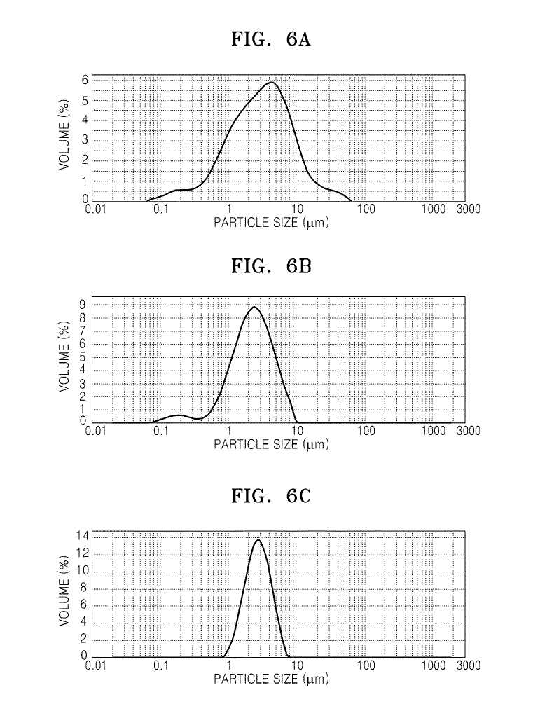

FIGS. 6A through 6C are graphs showing particle size distribution of anode active material powders ground by using a ball milling method, an attrition milling method, and an air jet milling method, respectively. More specifically, FIGS. 6A through 6C show particle size distributions of powders according to Embodiments 1, 5, and 8.

Referring to FIG. 6A, the graph shows a broad particle size distribution in a range from about less than 0.1 μm to about 61 μm. Also, for sizes less than 0.5 μm, a minor second distribution having a peak is shown. That is, it shows a bimodal particle size distribution having two peaks. Referring to FIG. 6B, it is observed that the powder has D1.0 of 9.95 μm, that is, particles having a size greater than 10 μm are all ground or filtered. However, it is also seen that particles having a size less than 0.5 μm have a second distribution having a peak. However, referring to FIG. 6C, the powder has D0.1 of 1.601 μm and D1.0 of 7.37 μm, that is, the powder has a narrow uniform particle size distribution. Also, fine particles having a size less than 1 μm are not observed, and a bimodal particle size distribution as shown in FIGS. 6A and 6B is not observed.

TABLE 1

| | Grinding | D0.1 | D0.5 | D0.9 | D1.0 |
|---|---|---|---|---|---|
| | condition | (μm) | (μm) | (μm) | (μm) |
| Embodiment 1 | Ball milling | 0.700 | 3.126 | 10.72 | 61.03 |
| Embodiment 5 | Attrition milling | 0.881 | 2.308 | 6.849 | 9.95 |
| Embodiment 8 | Air jet milling | 1.601 | 2.791 | 4.761 | 7.37 |

FIGS. 7A through 7C are graphs showing roundness, roughness, and anisotropy ratio of powders according to embodiments of the present invention. More specifically, FIGS. 7A through 7C respectively show particle size distributions of powders (respectively ground by ball milling, attrition milling, and air jet milling) according to Embodiments 1, 5, and 8.

After dispersing the powders for 5 minutes using a dispersing agent IPA, powder projections B were obtained by projecting 5024 particles, 5011 particles, and 5019 particles of each of the powders on a two-dimensional plane by using a powder shape measurement apparatus PITA-2 from Seishin Co.. Dimensions of an equivalent area circle C, a projected area A, a long particle diameter L, a short particle diameter S, an outline length P of plane-projected particle B, and a rounded outline length PE of a rounded outline D were measured, and an equivalent area diameter H, roundness R1, roughness R2, and anisotropy ratio R3 were calculated by using the measured dimensions. Table 2 summarizes the distribution of circular diameter H, roundness R1, roughness R2, and anisotropy ratio R3 of the powders.

TABLE 2

| | | Embodiment 1 | Embodiment 5 | Embodiment 8 |
|---|---|---|---|---|
| Grinding condition | | Ball milling | Attrition | Air jet milling |
| | | | milling | |
| Number of particles | | 5024 | 5011 | 5019 |
| (ea) | | | | |
| Equivalent | Average | 1.82 | 2.86 | 1.71 |
| area | Maximum | 12.73 | 11.61 | 10.91 |
| diameter | Minimum | 0.83 | 0.83 | 0.87 |
| H (μm) | SD | 0.851 | 1.165 | 0.819 |
| Roundness | Average | 0.900 | 0.873 | 0.929 |
| | Maximum | 1.000 | 1.000 | 1.000 |
| | Minimum | 0.438 | 0.504 | 0.339 |
| | SD | 0.065 | 0.060 | 0.047 |
| Roughness | Average | 0.967 | 0.966 | 0.967 |
| | Maximum | 0.999 | 0.997 | 0.999 |
| | Minimum | 0.902 | 0.887 | 0.879 |
| | SD | 0.008 | 0.008 | 0.008 |
| Aniso- | Average | 1.486 | 1.437 | 1.377 |
| tropy | Maximum | 4.798 | 3.207 | 3.427 |
| ratio | Minimum | 1.032 | 1.013 | 1.010 |
| | SD | 0.277 | 0.252 | 0.188 |

Referring to FIG. 7A, the powder according to Embodiment 8 has a roundness R1 closer to 1 than that of the powders according to Embodiments 1 and 5. Also, the average roundness of the powder of Embodiment 8 is 0.929, which is higher than 0.900 of Embodiment 1 and 0.873 of Embodiment 5, and the standard deviation (SD) of the powder of Embodiment 8 is 0.047, which is smaller than 0.065 of Embodiment 1 and 0.060 of Embodiment 5. That is, the powder according to Embodiment 8 may have a shape closer to that of a sphere and has a relatively uniform SD.

Referring to FIG. 7B, the powder according to Embodiments 1, 5, and 8 have an average roughness distribution from 0.966 to 0.967 and an SD of 0.008. The powders according to the embodiments of the present invention have a roughness close to 1, that is, have a smooth surface without having rough corrugates.

Referring to FIG. 7C, the powder according to Embodiment 8 has an anisotropy ratio closer to 1 than those of the powders according to Embodiments 1 and 5. Also, the powder of Embodiment 8 has an average anisotropy ratio of 1.377 which is closer to 1 than the average anisotropy ratios of 1.486 and 1.437 of the powders of Embodiments 1 and 5, respectively. Also, the powder of Embodiment 8 has an SD of 0.188 which is smaller than the standard deviations of 0.277 and 0.252 of Embodiments 1 and 5, respectively. That is, the powder of Embodiment 8 may have a shape close to that of a sphere and has a relatively uniform particle distribution, which is a similar result as in the roundness.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An anode active material for a lithium secondary battery, the anode active material comprising:
a silicon mono-phase; and
an alloy phase formed of silicon with at least one metal selected from the group consisting of Ti, Ni, Cu, Fe, Mn, Al, Cr, Co, and Zn,
wherein the anode active material is a powder in which the silicon mono-phase is uniformly distributed in a matrix of the alloy phase,
the powder has a particle size distribution defined as D0.1 and D0.9, and a D0.9-D0.1 value of the powder is in a range from about 3 μm to about 15 μm.

2. The anode active material of claim 1, wherein the value of D0.1 of the powder is greater than 1 μm.

3. The anode active material of claim 1, wherein the value of D0.9 of the powder is smaller than 16 μm.

4. The anode active material of claim 1, wherein the value of D0.1 of the powder is greater than 1 μm and the value of D0.9 of the powder is smaller than 10 μm.

5. The anode active material of claim 1, wherein the value of D0.1-D0.9 is in a range from about 3 μm to about 10 μm.

6. An anode active material for a lithium secondary battery, the anode active material comprising:
a silicon mono-phase; and
an alloy phase formed of silicon and a metal,
wherein the anode active material powder has a projected area A of a plane-projected powder particle and an outline length P of the plane-projected powder particle, and a roundness R1 of the particle is defined as
$$R 1 = \frac{2 \sqrt{π A}}{P} ,$$
wherein the anode active material powder has a roundness in a range from about 0.3 to about 1.0.

7. The anode active material of claim 6, wherein the plane-projected powder particle has a rounded outline D and a rounded outline length PE of the rounded outline D, and a roughness R2 is defined as R2=P/PE, wherein the anode active material powder has a roughness in a range from about 0.8 to about 1.0.

8. The anode active material of claim 6, wherein the anode active material has a long particle diameter L and a short particle diameter S of the plane-projected powder particle, and an anisotropy ratio R3 is defined as R3=L/S, wherein the anode active material has an anisotropy ratio in a range from about 1 to about 3.5.

9. A method of manufacturing an anode active material for a lithium secondary battery, the method comprising:
mixing silicon with a metal element at least one selected from the group consisting of Ti, Ni, Cu, Fe, Mn, Al, Cr, Co, and Zn;
cooling the mixture by using a melt spinner method; and
forming a powder by grinding the cooled mixture,
wherein D0.9-D0.1 of the manufactured powder has a value in a range from about 3 μm to about 15 μm.

10. The method of claim 9, wherein the forming of the powder comprises grinding the cooled mixture by using an air jet milling method.

11. The method of claim 9, wherein the forming of the powder comprises grinding the cooled mixture by using an attrition milling method.

12. The method of claim 9, wherein the powder has a particle diameter in a range from about 1 μm to about 10 μm.

13. A lithium secondary battery comprising an anode active material, the lithium secondary battery comprising:
a silicon mono-phase; and
an alloy phase formed of silicon and a metal,
wherein the anode active material powder has a projected area A of a plane-projected powder particle and an outline length P of the plane-projected powder particle, and a roundness R1 of the particle is defined as
$$R 1 = \frac{2 \sqrt{π A}}{P} ,$$
wherein the anode active material powder has a roundness R1 in a range from about 0.3 to about 1.0.
